(19) United States
(12) Patent Application Publication
(10) Pub. No.: US 2010/0076951 A1
(43) Pub. Date: Mar. 25, 2010

(54) SERVICE FOR NEGOTIATING A MEETING LOCATION GIVEN MULTIPLE USER PREFERENCES AND LOCATIONS USING SOCIAL NETWORKING

(75) Inventors: Ruthie D. Lyle, Durham, NC (US); Lisa Seacat DeLuca, San Francisco, CA (US)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: INTERNATIONAL BUSINESS MACHINES CORPORATION, Armonk, NY (US)

(21) Appl. No.: 12/208,507

(22) Filed: Sep. 11, 2008

(51) Int. Cl. G06F 7/06; G06F 17/30

(52) U.S. Cl. 707/706; 707/E17.014

(57) ABSTRACT

A computer-implemented method for providing a meeting location recommendation comprises receiving user preferences specifying types of recommendations to be provided, including defining which types of user ratings of services from a social networking service to consider, wherein at least a portion of the services being rated have respective service locations; receiving a meeting location recommendation request, including a list of participants; initiating a request to the social networking service to retrieve a subset of the user ratings based at least in part on the user preferences of the participants; and returning to the participants a list of the services and corresponding service locations specified in the subset of the user ratings to enable the participants to negotiate one of the service locations to serve as an agreed to meeting location.

### BACKGROUND OF THE INVENTION

People place a premium on face-to-face meetings, for both business and for social reasons. As people's schedules become increasingly busy, and as the number of people needing to attend a particular meeting increases, the difficulty in finding a meeting location increases. For example, consider the situation where four friends attempt to decide where to eat on a Friday night. Given each of the friends different interests and preferences in food and restaurant tastes, the decision of where to meet will more than likely require an extended discussion between the friends. The problem may even be made more complex when the friends are in different locations when the decision is being made.

### BRIEF SUMMARY OF THE INVENTION

Exemplary embodiments provide method and systems for providing a meeting location recommendation. Aspects of the exemplary embodiments comprise receiving user preferences specifying types of recommendations to be provided, including defining which types of user ratings of services from a social networking service to consider, wherein at least a portion of the services being rated have respective service locations; receiving a meeting location recommendation request, including a list of participants; initiating a request to the social networking service to retrieve a subset of the user ratings based at least in part on the user preferences of the participants; and returning to the participants a list of the services and corresponding service locations specified in the subset of the user ratings to enable the participants to negotiate one of the service locations to serve as an agreed to meeting location.

A further embodiment comprises receiving user preferences specifying types of recommendations to provide, including parameters defining which types of services to consider, wherein at least a portion of the services being rated have respective service locations; receive a meeting location recommendation request given a list of participants and participant locations for at least a portion of the participants; using at least a portion of the user preferences and the participant locations to query a service search site for a list of services having service locations in a vicinity of each of the participant locations; and returning to the participants a list of the services and corresponding service locations found by the query to enable the participants to negotiate one of the service locations to serve as an agreed to meeting location.

### BRIEF DESCRIPTION OF THE DRAWINGS

FIG. 1 is a diagram illustrating a meeting location recommendation system according to one exemplary embodiment.

FIG. 2 is a flow diagram illustrating a process for providing a meeting location recommendation according to an exemplary embodiment.

FIG. 3 is a diagram illustrating a visual representation of the recommended service locations sent to the participants by the meeting location recommendation service.

FIG. 4 is a diagram illustrating a meeting location recommendation system according to an alternate embodiment.

FIG. 5 is a flow diagram illustrating a process for providing a meeting location recommendation according to the alternate embodiment.

### DETAILED DESCRIPTION OF THE INVENTION

The present invention relates to a service for negotiating a meeting location given multiple user preferences and locations using a social networking service. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The exemplary embodiments provide a meeting location recommendation service that recommends meeting locations for two or more people to meet using information gathered from a social networking service.

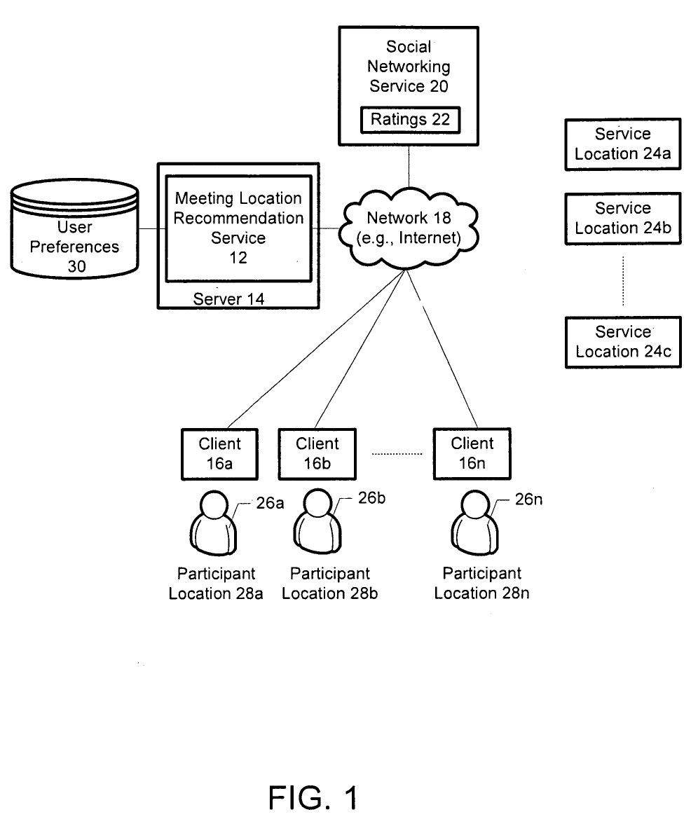

FIG. 1 is a diagram illustrating a meeting location recommendation system according to one exemplary embodiment. The system 10 may include a meeting location recommendation service 12 executing on a server 14 that is communication with a plurality of clients 16 (16a, 16b, 16n) over a network 18, such as the Internet, or a wireless or wired LAN, WLAN, or WMAX network. The meeting location recommendation service 12 is designed to support multiple users and may be web-based. The meeting location recommendation service 12 may be accessed by end-users via the clients 16, which in one embodiment may be web browsers. Alternatively, the clients 16 may be implemented as applications that run on end-user computing devices (e.g., PCs and mobile devices) and interface with the end-user's calendar management applications.

The system 10 may also include one or more social networking services 20 that communicate over the network 18. As used herein, a social networking service 20 is a site on the network 18 that requires membership to build an online community of people who share interests and activities, or who are interested in exploring the interests and activities of others, such as the posting of user ratings 22. Examples items for which user ratings 22 may be provided include services that have actual physical service locations 24 (24a, 24b, 24n) that can be visited by people, such as restaurants and professional services, for instance. The social networking service 20 may store the service location 24 for each rated service in the form of business contact information (e.g., address, telephone number, store hours, and the like). The social networking service 20 may be web-based and may allow a variety of ways for members to interact, such as e-mail and instant messaging services. Examples of well-known social working services currently include Facebook, Myspace, and Yelp.

Users of the meeting location recommendation service 12, who may be also referred to as meeting participants 26 (26a, 26b, 26n), may desire to have a meeting from time to time. Each participant 26 may be in a same or different geographic participant location 28 (28a, 28b, 28n). Given the user's different interests, location preferences and the fact that the user's may be geographically distributed when deciding where to meet, the participants 26 may have a difficult time finding a meeting location that works best for all participants 26.

According to the exemplary embodiment, the meeting location recommendation service 12 allows an end-user to place a request for a meeting location recommendation for a list of participants 26, and in response, receive a list of recommended meeting locations using information gathered from the social networking service 20. In one embodiment, for example, based on the user preferences 30 of the participants and each of the participant locations 28 (which may include a current, future or dynamically changing location), the user ratings 22 of the social networking service 20 may be queried for a list of services having service locations 24 in a vicinity of each of the participants 26 and that are either highly rated by the participants, or that have ratings matching parameters in the participant's user preferences 30.

Although the exemplary embodiment is shown in which the meeting location recommendation service 12 is server 14 based, in an alternative embodiment, the meeting location recommendation service 12 may be implemented as a stand-alone application that runs on an end-user computing device and queries the social networking service 20. In yet another embodiment, the meeting location recommendation service 12 and the user preferences 30 may be provided as part of the social networking service 20.

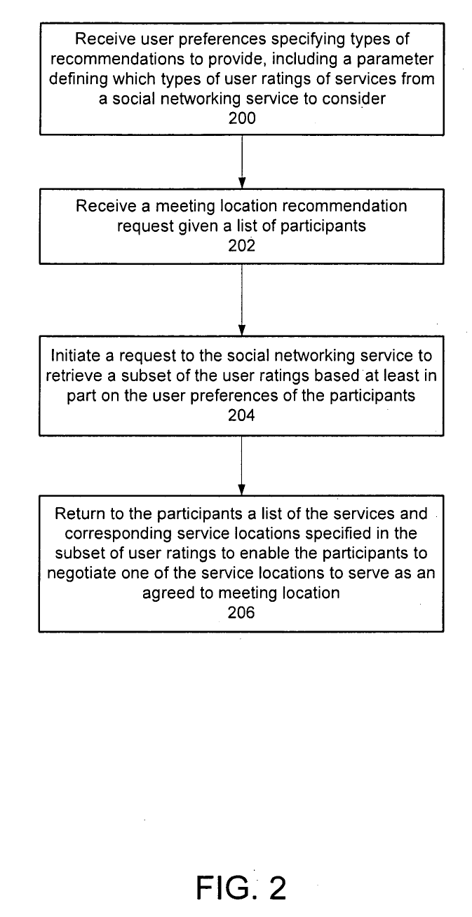

FIG. 2 is a flow diagram illustrating a process for providing a meeting location recommendation according to an exemplary embodiment. The process may begin by the meeting location recommendation service 12 receiving user preferences 30 specifying types of recommendations to provide, including a parameter defining which types of user ratings of services from a social networking service to consider (block 200). In the exemplary embodiment, each user of the meeting location recommendation service 12 may be required to sign up and become members of the meeting location recommendation service 12. Part of the sign up process for each user may be defining his or her own user preferences 30. The user preferences 30 relate to the reasons the participants 26 would meet, such food preferences, places the participants like to visit together, and the like.

Accordingly, each participant 26 defines the types of user ratings 22 that the meeting location recommendation service 12 should consider from the social networking service 20 when making the meeting location recommendations. In the embodiment where the meeting location recommendation service 12 is a separate from the social networking service 20, the participant 26 should also include an identification of each social networking service from which user ratings 22 should be used to form meeting location recommendations, as well as the log-in information for each service.

The user preferences 30 may also include a parameter defining user group/friend affiliations in the social networking service for which user ratings 22 should be considered when making the meeting location recommendations. For example, a particular participant 26 may belong to the University of North Carolina alumni club, and may specify in his or her user preferences 30 that meeting location recommendations should only be formed from the ratings that were posted by other University of North Carolina alumni club members in the social networking service 20.

The user preference 30 may also include a parameter defining location preference information defining a location range(s) within which a meeting location should fall within a participant's location. Different location ranges may be set for different cities or for different areas of the same city. In one embodiment, the location range(s) may be specified in a distance, such as miles, and continually updated by the participant 26 to narrow or widen the list of recommended service locations provided.

The user preferences 30 may also include a parameter defining user application and device contact information indicating where the meeting location recommendation service 12 should send the meeting location recommendation to each respective participant 26. Examples may include a cell phone number for a text message, an e-mail address, or a fax number, for instance.

The user preferences 30 may also include a parameter defining a ratings threshold that enables users to set a minimum ratings value that services are required to meet in order to be considered during the recommendation process.

The meeting location recommendation service 12 receives a meeting location recommendation request, including a list of participants 26 (block 202). In one embodiment, the meeting location recommendation request is made by one of the participants 26 of the meeting. In another embodiment, the meeting location recommendation request may be placed by a user on behalf of the participants 26 of the meeting. In one embodiment, the meeting location request is sent along with a list identifying the participants 26 the user would like to consult with in the final meeting location decision. In another embodiment, the list of participants 26 may be sent apart from the meeting location request.

In one embodiment, the meeting location request may further include participant location 26 information for each of the participants 26. In one embodiment, the participant location information comprises a current location of each of the participants 26. In another embodiment, the participant location information comprises a future location of each of the participants 26. In yet another embodiment, the participant location information comprises a dynamically changing location of each of the participants 26. For example, such as in a situation where each of the participants are in a moving vehicle.

In one embodiment, once a user makes a meeting location recommendation request, the user may have applications and/or devices that are predefined in their user preferences 30 in which to send a list of recommended meeting locations. However, in another embodiment, the meeting location request may further include the contact information of the application/device used to send the meeting location request, such that the list of recommended service locations (and the final negotiated meeting location) is returned to the same application/device and stored. Examples include a calendaring program, a GPS device, an e-mail, a text message via a cell phone number, and the like.

The meeting location recommendation service 12 initiates a request to the social networking service 20 to retrieve a subset of the user ratings 22 based at least in part on the user preferences 30 of the participants 26 (block 204). If the user preferences 30 of the participants 26 are not available to the social networking service 20, the request may include a pointer to the user preferences 30.

In one embodiment, the social networking service 20 may use the rating thresholds of the user preferences 30 of the participants 26 to retrieve the subset of the user ratings 22, such that the social networking service 20 retrieves the user ratings 22 of the services that have been rated equal to or higher than the ratings threshold of at least a portion of the participants 26.

In the same or different embodiment, the social networking service 20 uses the location information in the user preferences 30 of the participants 26 to retrieve the subset of the user ratings 22, such that the social networking service 20 retrieves the user ratings 22 of the services having service locations in a vicinity of the location of the participants 26. In this embodiment, the size of vicinity is restricted by the location range preference defined by each participant 26 in his or her user preferences 30.

A list of the services and corresponding service locations 24 specified in the subset of the user ratings is then returned to the participants 26 to enable the participants 26 to negotiate one of the service locations to serve as an agreed to meeting location (block 206). The list of recommended services may be returned additional information including, a subset or average of the user ratings 22, contact information of the services, and driving directions, for example. In an exemplary embodiment, the list of recommended services and service locations 24 may be returned to the participants with a visual representation of the service locations 24 shown on a map. Alternatively, the list of recommended services may be returned with a link to a visual representation of the service locations 24 on a map.

In one embodiment, the social networking service 20 returns the list of the services and service locations to the meeting location recommendation service 12, which may then forward the list to the participants 26 via their preferred application/device. In another embodiment, the social networking service 20 may return a list of the services and service locations directly to the participants 26.

In response to receiving a selection of the agreed to meeting location, the meeting location recommendation service 12 may add the meeting location to each participant's specified storage application/device. In a further embodiment, the participants may also be prompted to negotiate a meeting date and time, which may also be added to each participant's specified storage application/device. The information added to a participant's storage application/device can also include driving directions to the meeting location as well as contact information for the service, such as telephone number, for example. In the case where the participant's device is a navigation device, driving directions may be dynamically determined based on the contact information received for the service.

If at any time the location information for a participant 26 changes prior to the meeting, then the meeting location recommendation service 12 may automatically send alternative meeting location recommendations to be negotiated by the participants based on this change.

If a new participant 26 is invited, and the a participant 26 is invited to the beginning of the process, that participant's user preferences 30 are retrieved and then blocks 202 through 206 may be repeated to include the new participant 26. If the new participant 26 is invited near the end of the process, then the negotiation process could be repeated, or the new participant could be informed of the agreed to meeting location and the meeting location added to the new participant's specified application/device.

To further illustrate embodiments of the above system, consider the following user scenario. Using mobile devices, Ruthie asks Lisa to meet for drinks via the meeting location recommendation service 12. Lisa sends a response of yes to Ruthie, and Ruthie sends a recommendation request to the meeting location recommendation service 12 along with Ruthie and Lisa user ID's and the current location information. If Lisa's user preferences 30 are not available, then Ruthie can pass along with the request a pointer to Lisa's user preferences 30. The meeting location recommendation service 12 may then initiate a request to Yelp for Italian restaurants in the vicinity of Ruthie and Lisa based on Ruthie and Lisa's user preferences 30.

In one embodiment, the current location of Ruthie and Lisa is assumed based on location information passed in the request from Ruthie and Lisa's mobile devices (e.g., GPS information, cell tower triangulation, ISP location, and the like). In another embodiment, a future location of Ruthie and Lisa can be specified. For example, when they both anticipate being in Paris on a particular date and wish to arrange a place to meet based on their own and their friends preferences and reviews. In another embodiment, Ruthie and Lisa's location can change dynamically, such as when Ruthie and Lisa are driving home from work, which would require periodic update requests to the meeting location recommendation service 12.

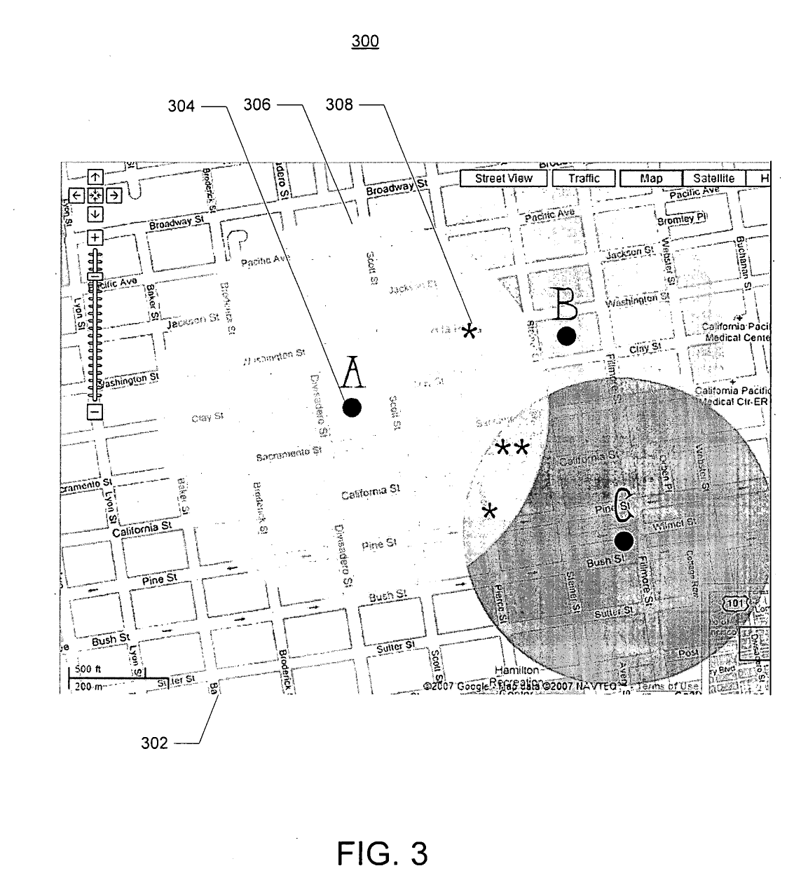

FIG. 3 is a diagram illustrating a visual representation of the recommended service locations sent to the participants by the meeting location recommendation service. According to an exemplary embodiment, the visual representation 300 displays on a map 302, each participant location 304 (A, B, C), and around each participant location 304, a location range 306 (shown by shaded circles) within which a meeting location should fall within the participant's location 304 as set in that participant's user preferences 30. The visual representation also displays the service locations 308 of the recommended services (shown as “*”) that meet the user preferences criteria of the participants. The service locations 308 falling within the location range 306 of all three participants are the most convenient meeting locations for all the participants.

In one embodiment, if the participants have GPS enabled devices, after the participants have selected a meeting location, the visual representation 300 may display not only the location of each participant, but also estimated arrival times of each of the participants. Each participant may further choose an option to see whether each of the other participants have visited the service at the meeting location in the past and if so, view the user ratings 22 that each of those participants gave the service.

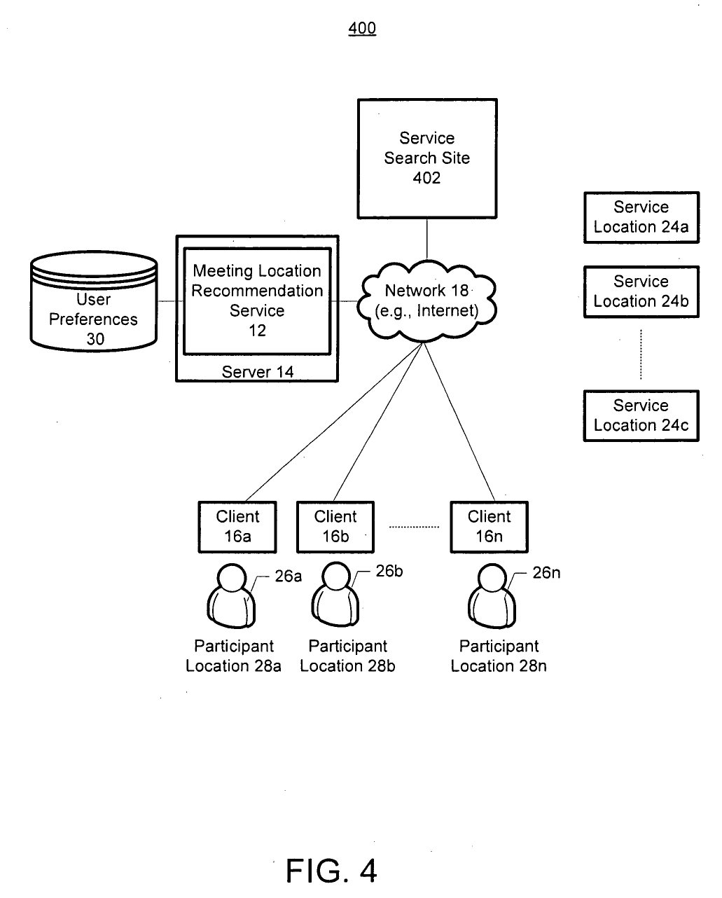

FIG. 4 is a diagram illustrating a meeting location recommendation system 400 according to an alternate embodiment, where like components from FIG. 1 have like reference numerals. In this embodiment, the meeting location recommendation service 12 may communicate over the network 18 with a service search site 402. As used herein, a service search site 402 is a site on the network 18 that based on entered search criteria, performs electronic searches for services, including services that have actual physical service locations 24 (24a, 24b, 24n) that can be visited by people, such as restaurants and professional services, for instance. The social networking service 20 may store the service location 24 for each rated service in the form of business contact information (e.g., address, telephone number, store hours, and the like). The service search site 20 may be web-based and examples of well-known service search sites currently include waiter.com, maps.yahoo.com, and citysearch.com.

According to the exemplary embodiment, the meeting location recommendation service 12 allows an end-user to place a request for a meeting location recommendation for a list of participants 26, and in response, receive a list of recommended meeting locations using information gathered from the service search site 402.

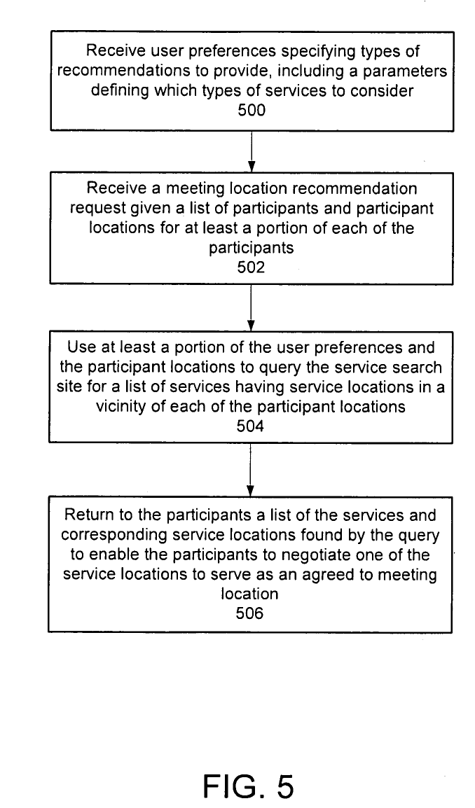

FIG. 5 is a flow diagram illustrating a process for providing a meeting location recommendation according to the alternate embodiment. The process may begin by the meeting location recommendation service 12 receiving user preferences 30 specifying types of recommendations to provide, including a parameters defining which types of services to consider (block 500).

The meeting location recommendation service 12 receives a meeting location recommendation request given a list of participants 26 and participant locations 26 for at least a portion of each of the participants 26 (block 502). In one embodiment, the participant location information comprises a current location of the participants 26. In another embodiment, the participant location information comprises a future location of each of the participants 26. In yet another embodiment, the participant location information comprises a dynamically changing location of each of the participants 26. For example, such as in a situation where each of the participants are in a moving vehicle.

The meeting location recommendation service 12 uses at least a portion of the user preferences 30 and the participant locations 26 to query the service search site 402 for a list of services having service locations 24 in a vicinity of each of the participant locations 28 (block 504). In one embodiment, the parameters values in the user preferences 30 may be used as search criteria values when querying the service search site 402. For example, if a user specifies that his/her favorite type of food is “Italian” in his/her user preferences 30, then “Italian” may be used as the search string in a service search site in which a value may be entered for “type of restaurant?” The list of restaurants returned by the search may then be narrowed based on the participant locations 28 and the user's location preference information defining location range(s) within which a meeting location should fall within a participant's location.

A list of the services and corresponding service locations 24 found by the query is then returned to the participants 26 to enable the participants 26 to negotiate one of the service locations to serve as an agreed to meeting location, as described above (block 506).

A system of method and system for providing a meeting location recommendation service has been disclosed. The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A computer-implemented method for providing a meeting location recommendation, comprising:
receiving user preferences specifying types of recommendations to provide, including defining which types of user ratings of services from a social networking service to consider, wherein at least a portion of the services being rated have respective service locations;
receiving a meeting location recommendation request given a list of participants;
initiating a request to the social networking service to retrieve a subset of the user ratings based at least in part on the user preferences of the participants; and
returning to the participants a list of the services and corresponding service locations specified in the subset of the user ratings to enable the participants to negotiate one of the service locations to serve as an agreed to meeting location.

2. The method of claim 1 wherein in response to receiving a selection of the agreed to meeting location, the meeting location is added to at least one of each participant's specified storage application and device.

3. The method of claim 1 wherein the meeting location recommendation request further includes location information for each of the participants comprising at least one of a current location of each of the participants, a future location of each of the participants, and a dynamically changing location of each of the participants.

4. The method of claim 1 wherein the social networking service retrieves the user ratings of the services that have been rated equal to or higher than a ratings threshold of at least a portion of the participants.

5. The method of claim 1 wherein the social networking service retrieves the user ratings of the services having service locations in a vicinity of a location of the participants.

6. The method of claim 1 wherein the list of the services and service locations is returned to the participants with additional information including at least one of an average of the user ratings, contact information, and driving directions.

7. The method of claim 1 wherein the list of the services and service locations is returned to the participants with a visual representation of the service locations shown on a map.

8. The method of claim 7 wherein after the participants have selected the meeting location, the visual representation displays estimated arrival times of each of the participants.

9. The method of claim 7 wherein each of the participants may further choose an option to see whether other participants have visited the service at the meeting location and if so, view the user ratings that each of those participants gave the service.

10. The method of claim 1 wherein the user preferences further comprise a parameter defining at least one of group and friend affiliations in the social networking service for which ratings should be considered when making the meeting location recommendations.

11. The method of claim 1 wherein the user preferences further comprise a parameter defining location preference information defining a location range within which the meeting location should fall within a participant's location.

12. The method of claim 1 wherein the user preferences further comprise a user application and device contact information indicating where the meeting location recommendation should be sent to each respective participant.

13. A system comprising:
a server;
user preferences accessible by the server specifying types of recommendations to provide, including defining which types of user ratings of services from a social networking service to consider, wherein at least a portion of the services being rated have respective service locations;
a meeting location recommendation service executing on the server; and
wherein in response receiving a meeting location recommendation request given a list of participants, the meeting location recommendation service application functions to:
initiating a request to the social networking service to retrieve a subset of the user ratings based at least in part on the user preferences of the participants; and
returning to the participants a list of the services and corresponding service locations specified in the subset of the user ratings to enable the participants to negotiate one of the service locations to serve as an agreed to meeting location.

14. The system of claim 13 wherein in response to receiving a selection of the agreed to meeting location, the meeting location is added to at least one of each participant's specified storage application and device.

15. The system of claim 13 wherein the meeting location recommendation request further includes location information for each of the participants comprising at least one of a current location of each of the participants, a future location of each of the participants, and a dynamically changing location of each of the participants.

16. The system of claim 13 wherein the social networking service retrieves the user ratings of the services that have been rated equal to or higher than a ratings threshold of at least a portion of the participants.

17. The system of claim 13 wherein the social networking service retrieves the user ratings of the services having service locations in a vicinity of a location of the participants.

18. The method of claim 1 wherein the list of the services and service locations is returned to the participants with additional information including at least one of an average of the user ratings, contact information, and driving directions.

19. The system of claim 13 wherein the list of the services and service locations is returned to the participants with a visual representation of the service locations shown on a map.

20. The system of claim 19 wherein after the participants have selected the meeting location, the visual representation displays estimated arrival times of each of the participants.

21. The system of claim 19 wherein each of the participants may further choose an option to see whether other participants have visited the service at the meeting location and if so, view the user ratings that each of those participants gave the service.

22. The system of claim 13 wherein the user preferences further comprise a parameter defining at least one of group and friend affiliations in the social networking service for which ratings should be considered when making the meeting location recommendations.

23. The system of claim 13 wherein the user preferences further comprise a parameter defining location preference information defining a location range within which the meeting location should fall within a participant's location.

24. The system of claim 13 wherein the user preferences further comprise a user application and device contact information indicating where the meeting location recommendation service should send a meeting location recommendation to each respective participant.

25. A computer-implemented method for providing a meeting location recommendation, comprising:
receiving user preferences specifying types of recommendations to provide, including parameters defining which types of services to consider, wherein at least a portion of the services being rated have respective service locations;
receive a meeting location recommendation request given a list of participants and participant locations for at least a portion of the participants;
using at least a portion of the user preferences and the participant locations to query a service search site for a list of services having service locations in a vicinity of each of the participant locations; and
returning to the participants a list of the services and corresponding service locations found by the query to enable the participants to negotiate one of the service locations to serve as an agreed to meeting location.
